(19) United States
(12) Patent Application Publication
(10) Pub. No.: US 2024/0375325 A1
(43) Pub. Date: Nov. 14, 2024

(54) PROCESS FOR THE PRODUCTION OF SHAPED OBJECTS OF ULTRA-HIGH MOLECULAR WEIGHT POLYETHYLENES

(71) Applicant: SABIC Global Technologies B.V., Bergen op Zoom (NL)

(72) Inventors: Zahir Bashir, Trivandrum (IN); Fayez Abdullah Alfayez, Riyadh (SA); Yousof Mustafa Ghazzawi, Riyadh (SA)

(21) Appl. No.: 18/683,192

(22) PCT Filed: Jul. 11, 2022
(86) PCT No.: PCT/EP2022/069217

§ 371 Date: Feb. 12, 2024

(30) Foreign Application Priority Data
Aug. 17, 2021 (EP) 21191803.2

(51) Int. Cl. B29C 43/00; B29C 43/52; B29K 23/00; B29K 105/00; B29L 15/00

(52) U.S. Cl. CPC B29C 43/003; B29C 43/006; B29C 43/52; B29K 2023/0683; B29K 2105/251; B29L 2015/003

(57) ABSTRACT

A process for the production of a shaped object, including: (a) providing a mould including a cavity formed to produce an object of a desired shape; (b) heating the mould to a temperature of ≥145° C.; (c) supplying an ultra-high molecular weight polyethylene (UHMWPE) material into the mould; (d) closing the mould with a punch counterpart having such shape as to fit together with the mould cavity to form the shape of the desired object; (e) applying a compaction pressure through the punch to the material that is present in the mould, whilst maintaining the mould temperature, for such a compaction time that the material fuses to form the desired shape; (f) releasing the compaction pressure and removing the shaped object from the mould at a temperature of ≥145° C.; and (g) cooling the shaped object to a temperature of below the melting temperature of the UHMWPE material.

### CROSS-REFERENCE TO RELATED APPLICATIONS

This application is a National Stage application of PCT/EP2022/069217, filed Jul. 11, 2022, which claims the benefit of European Application No. 21191803.2, filed Aug. 17, 2021, both of which are incorporated by reference in their entireties herein.

### BACKGROUND

The present invention relates to a process for the production of shaped objects, such as shaped objects having a complex shape structure, of ultra-high molecular weight polyethylenes. The invention also relates to shaped objects produced according to the process of the invention.

Ultra-high molecular weight polyethylenes, commonly also referred to as UHMWPE, are a class of materials that offer a particular set of properties that render them suitable for certain high-demanding applications. In particular, shaped objects of UHMWPE typically demonstrate extremely high wear and friction characteristics. In addition, UHMWPE has a density that is far lower than many materials, rendering it a suitable material where lightweight solutions are desired. Further, shaped objects of UHMWPE have a high degree of chemical resistance.

For that reason, UHMWPE is a desirable material to manufacture objects where one or more of the above characteristics are required, such as for example certain moving parts, like cogwheels, gears, wheels, as well as certain sliding surface objects such as guide rails. However, many other applications exist or are suited for UHMWPE-based shaped objects.

In order to manufacture such objects, the UHMWPE material needs to be formed into the desired shape that is required for the object. Typically, UHMWPE is available as a powder-form material from its production, which typically involves a polymerisation process based on ethylene gas. In contrast to other polyethylene materials of a lower molecular weight, UHMWPE does not suitably allow itself to be processed into a shape by heating it to a molten condition and subsequently forcing the material in molten form into a certain shape as is desired. This is due to the fact that UHMWPE typically does not form a matter that demonstrates sufficient flow under force. Accordingly, UHMWPE typically cannot be converted into shaped parts by conventional moulding techniques such as melt extrusion moulding or injection moulding.

In order to be able to manufacture objects using UHMWPE materials, in particular where such objects have a certain complex shape, typically manufacturing methods such as machining based on solid blocks or rods of UHMWPE materials are employed. Such methods however have their disadvantages. For example, the machining of an object tends to result in a large amount of waste material in the form of shavings that are machined off from the original block to arrive at the desired shape. Further, production of an object by machining is a quite time-consuming process.

### SUMMARY

Therefore, there maintains to be a desire to be able to manufacture complex shaped objects from UHMWPE materials in an economical and fast way. This is now provided according to the present invention by a process comprising the steps in this order of:
(a) providing a mould comprising a cavity formed to produce an object of a desired shape;
(b) heating the mould to a temperature of ≥145° C.;
(c) supplying a quantity of an ultra-high molecular weight polyethylene (UHMWPE) material into the mould;
(d) closing the mould with a counterpart punch having such shape as to fit together with the mould cavity to form the shape of the desired object;
(e) applying a compaction pressure through the punch to the material that is present in the mould, whilst maintaining the mould temperature, for such a compaction time that the material fuses to form the desired shape;
(f) releasing the compaction pressure and removing the shaped object from the mould at a temperature of ≥145° C.; and
(g) cooling the shaped object to a temperature of below the melting temperature of the UHMWPE material.

Such process allows for the production of an object from UHMWPE that has high strength and toughness, can have a complex shape, in a fast and economical manner, without resulting in a large amount of waste UHWMPE material such as would be the case in forming an object by machining.

### BRIEF DESCRIPTION OF THE DRAWINGS

For a more complete understanding, reference is now made to the following descriptions taken in conjunction with the accompanying drawings, in which:

FIG. 1 is an image of the surface of a fracture of Example 1;

FIG. 2 is an image of the surface of a fracture of Example 2;

FIG. 3 is an image of the surface of a cut of Example 3;

FIG. 4 is an image of the surface of a cut of Example 4;

FIG. 5 is an image of the surface of a cut of Example 5;

FIG. 6 is an image of the surface of a cut of Example 6;

FIG. 7 is an image of the surface of a cut of Example 7;

FIG. 8 is an image of the surface of a cut of Example 8; and

FIG. 9 is an image of the surface of a cut of Example 9.

### DETAILED DESCRIPTION

The process of the present invention has certain benefits over conventional compaction moulding processes wherein materials are used that, when subjected to temperatures above their melting point, form a liquid flowing matter. UHMWPE, even when heated to above its melting point, does not form liquid flowing matter. This allows the UHMWPE product as produced according to the process of the present invention to be demoulded at high temperatures, such as the moulding temperature. An advantage thereof is that the temperature of the mould can be kept at the high temperature required for the moulding step; no cooling cycle, wherein the material forming the object is cooled to a certain temperature below its melting temperature, which typically is necessary to enable demoulding of a formed object without shape deformation, is required. The fact that the mould thus can be kept at constant operating temperature has an advantage in that the cycle time is significantly reduced, since demoulding of the formed object can be done immediately after release of pressure, upon which the mould may be filled with material for a new shaping cycle immediately. A further advantage is that, due to the fact that no cooling and re-heating is required, the energy consumption during the shaping process is reduced.

A further advantage of being able to demould the shaped object at high temperatures above the melting temperature, as in the present process, is that the formed objects may immediately upon moulding be stored in such way that they contact one another, such as by stacking or piling. The hot compaction process using UHWMPE as per the present invention results in shaped objects that as the demoulding temperature do not stick to each other.

In the process of the present invention, the temperature to which the mould is heated prior to compaction is ≥145° C., preferably ≥145° C. and ≤180° C., more preferably ≥160° C. and ≤180° C., even more preferably ≥165° C. and ≤180° C. Such pre-heating temperature contributes to the formation of a shaped object with good shape retention, high strength, without formation of defects.

In the process of the present invention, the temperature at which compaction takes place is ≥145° C., preferably ≥145° C. and ≤180° C., more preferably ≥160° C. and ≤180° C., even more preferably ≥165° C. and ≤180° C. Such compaction temperature contributes to the formation of a shaped object with good shape retention, high strength, without formation of defects.

Preferably, the temperature to which the mould is heated prior to compaction is ≥145° C., preferably ≥145° C. and ≤180° C., more preferably ≥160° C. and ≤180° C., even more preferably ≥ 165° C. and ≤180° C., and the temperature at which compaction takes place is ≥145° C., preferably ≥145° C. and ≤180° C., more preferably ≥160° C. and ≤180° C., even more preferably ≥165° C. and ≤180° C.

Particularly preferably, the temperature to which the mould is heated prior to compaction is ≥145° C., preferably ≥145° C. and ≤180° C., more preferably ≥160° C. and ≤180° C., even more preferably ≥165° C. and ≤180° C., and the temperature at which compaction takes place is ≥ 145° C., preferably ≥145° C. and ≤180° C., more preferably ≥160° C. and ≤180° C., even more preferably ≥165° C. and ≤180° C., and the temperature to which the mould is heated prior to compaction is equal to the compaction temperature.

Due to the very high molecular weight of UHMWPE, it is difficult to analyse its molar mass by for instance Gel Permeation Chromatography (GPC) or Size Exclusion Chromatography (SEC). Alternatively, the so-called Elongational Stress can be determined according to ISO-11542-2:1998. This Elongational Stress, sometimes also referred to as “Flow Value”, can subsequently be translated into the molecular weight as disclosed for example by J. Berzen et al. in The British Polymer Journal, Vol. 10, December 1978, pp 281-287.

It is preferred that the UHWMPE material is a polyethylene material having a molecular weight of ≥500,000 g/mol, preferably ≥1,000,000 g/mol, more preferably ≥1,000,000 and ≤10,000,000 g/mol, even more preferably ≥2,000,000 and ≤10,000,000 g/mol, yet even more preferably ≥5,000,000 and ≤10,000,000 g/mol.

For example, the UHMWPE material may have an elongational stress as measured according to ISO 11542:1998 of <0.5 MPa, preferably <0.4 MPa, more preferably <0.3 MPa, even more preferably <0.2 MPa.

The UHMWPE material may for example be supplied to the mould in the form of a powder. It is preferred that such UHMWPE powder has an average particle size D₅₀ as measured according to ISO-13320:2009 of <250 μm, preferably <200 μm, more preferably <175 μm.

The UHMWPE powder may be supplied to the mould at room temperature, or may be supplied to the mould at a temperature of ≥70° C. and ≤190° C., more preferably of ≥100° C. and ≤180° C.

The process may be performed at a compaction pressure of >1.0 MPa, preferably >5.0 MPa, more preferably >10.0 MPa, even more preferably >20.0 MPa. For example, the process may be performed at a compaction temperature of >1.0 MPa and <100.0 MPa, preferably of >5.0 MPa and <50.0 MPa, more preferably of >10.0 MPa and <40.0 MPa, even more preferably of >20.0 MPa and <40.0 MPa.

The compaction time of the process may for example be ≥1.0 and ≤15.0 minutes, preferably ≥2.0 and ≤10.0 minutes, more preferably ≥3.0 and ≤7.0 minutes.

The invention also relates to a shaped object produced according to the process of the invention. In particular, the object may be a gear or an object with unlimited complexity in the plane parallel to the pressing punch of the mould.

The invention will now be illustrated by the following non-limiting examples.

Using an UHMWPE material GUR 4150, having a molecular weight of 8.7×10⁶ g/mol, a number of compaction examples were performed as further described here below.

As compaction die, an insulated cylindrical die having cavity having a diameter of 15 mm and a depth of 5 cm was used. The die could be closed with a cylindrical punch to so form a cylindrical form in the mould. In the compaction experiments of the invention, the die was filled to 60% of its depth with the UHMWPE.

### Example 1: Compaction at 145° C.

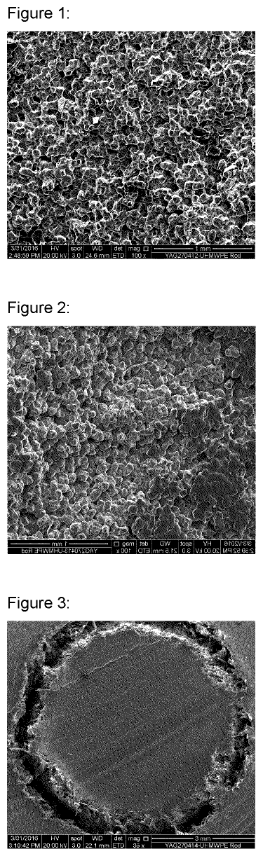

The die and punch were pre-heated to 145° C., upon which the die was filled to 60% of its depth with the UHMWPE. The punch was placed in the corresponding opening of the die cavity, and a force of 25 MPa was exerted onto the punch. The pressure and temperature were maintained for a period of 5 minutes, upon which the pressure was released, and the formed cylindrical object was removed from the mould, without cooling. When removing from the mould at the moulding temperature of 145° C., the object did not deform, nor exhibited die swell. Upon cooling to room temperature, the object crystallised and became white. No warping occurred. Subsequently, the object was fractured by force, and the surface of the fracture was studied, showing a granular surface with discernible powder boundaries. An image of the surface is presented in FIG. 1.

### Example 2: Compaction at 160° C.

The experiment of example 2 was conducted under conditions similar to those of example 1, differing only in that the pre-heating temperature of the mould was 160° C., and that that temperature was maintained during the compaction. The object formed by this compaction could also be removed from the mould at the moulding temperature without deformation. After cooling and force fracturing, the surface of the fracture also showed a granular surface with discernible powder boundaries, albeit also showing certain portions where powder particles appear to be fused. An image of the surface is presented in FIG. 2.

### Example 3: Compacting at 165° C.

The experiment of example 3 was conducted under conditions similar to those of example 1, differing only in that the pre-heating temperature of the mould was 165° C., and that that temperature was maintained during the compaction. The object formed by this compaction could also be removed from the mould at the moulding temperature without deformation. After cooling and cutting, the surface of the cut showed a largely fused surface. An image of the surface is presented in FIG. 3.

### Example 4: Compacting at 170° C.

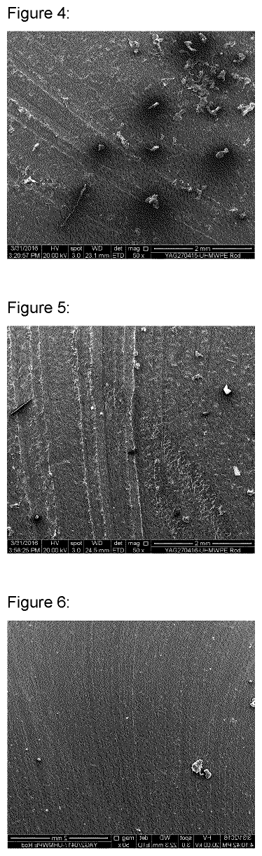

The experiment of example 4 was conducted under conditions similar to those of example 1, differing only in that the pre-heating temperature of the mould was 170° C., and that that temperature was maintained during the compaction. The object formed by this compaction could also be removed from the mould at the moulding temperature without deformation, wherein the object at discharging was viscous, indicating it to be in molten condition. After cooling and cutting, the surface of the cut showed a fused surface. Cutting was extremely tough. An image of the surface is presented in FIG. 4.

### Example 5: Compacting at 175° C.

The experiment of example 5 was conducted under conditions similar to those of example 1, differing only in that the pre-heating temperature of the mould was 175° C., and that that temperature was maintained during the compaction. The object formed by this compaction could also be removed from the mould at the moulding temperature without deformation, wherein the object at discharging was viscous, indicating it to be in molten condition. After cooling and cutting, the surface of the cut showed a fused surface. Cutting was extremely tough. An image of the surface is presented in FIG. 5.

### Example 6: Compacting at 180° C.

The experiment of example 6 was conducted under conditions similar to those of example 1, differing only in that the pre-heating temperature of the mould was 180° C., and that that temperature was maintained during the compaction. The object formed by this compaction could also be removed from the mould at the moulding temperature without deformation, wherein the object at discharging was viscous, indicating it to be in molten condition. After cooling and cutting, the surface of the cut showed a fused surface. Cutting was extremely tough. An image of the surface is presented in FIG. 6.

### Example 7: Compacting at 185° C.

The experiment of example 7 was conducted under conditions similar to those of example 1, differing only in that the pre-heating temperature of the mould was 185° C., and that that temperature was maintained during the compaction. The object formed by this compaction could also be removed from the mould at the moulding temperature without deformation, wherein the object at discharging was viscous, indicating it to be in molten condition. After cooling and cutting, the surface of the cut showed a fused surface, but showed certain surface defects by voids. An image of the surface is presented in FIG. 7.

### Example 8: Compacting at 190° C.

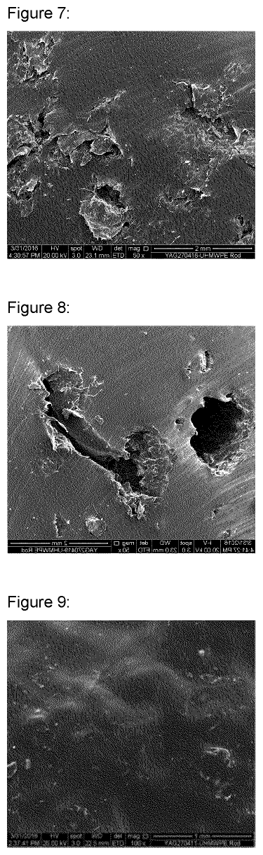

The experiment of example 8 was conducted under conditions similar to those of example 1, differing only in that the pre-heating temperature of the mould was 190° C., and that that temperature was maintained during the compaction. The object formed by this compaction could also be removed from the mould at the moulding temperature without deformation, wherein the object at discharging was viscous, indicating it to be in molten condition. After cooling and cutting, the surface of the cut showed a fused surface, but showed more certain surface defects by voids then was the case in example 7. An image of the surface is presented in FIG. 8.

### Example 9 (Comparative): Compaction at 50° C.

The experiment of example 9 was conducted by pre-heating the mould that was also used in example 1-8 to a temperature of 50° C., filling the die to 60% depth, and subjecting the mould to a compaction pressure of 25 MPa for a period of 5 minutes, after which the pressure was released. The object that was formed had no mechanical strength and was powdery. In order to form a consolidated object, the cylinder was heated to 180° C. outside the die, for a period of 30 minutes. During this process, a certain degree of sintering occurred, and the object expanded in length by so-called axial spring-back. The object was cut, and the surface of the cut showed a certain degree of fusion; however, this process suffers from the drawbacks that the object is deformed during the pressureless sintering step, and that the total shaping time is larger than in the hot compaction of examples 1-8. The cut surface of the object is presented in FIG. 9.

1. Process for the production of a shaped object, wherein the process comprises the steps in this order of:
(a) providing a mould comprising a cavity formed to produce an object of a desired shape;
(b) heating the mould to a temperature of ≥145° C.;
(c) supplying a quantity of an ultra-high molecular weight polyethylene (UHMWPE) material into the mould;
(d) closing the mould with a counterpart punch having such shape as to fit together with the mould cavity to form the shape of the desired object;
(e) applying a compaction pressure through the punch to the material that is present in the mould, whilst maintaining the mould temperature, for such a compaction time that the material fuses to form the desired shape;
(f) releasing the compaction pressure and removing the shaped object from the mould at a temperature of ≥145° C.; and
(g) cooling the shaped object to a temperature of below the melting temperature of the UHMWPE material.

2. Process according to claim 1, wherein the UHWMPE material is a polyethylene material having a molecular weight of ≥500,000 g/mol.

3. Process according to claim 1, wherein the UHMWPE material has an elongational stress as measured according to ISO 11542:1998 of <0.5 MPa.

4. Process according to claim 1, wherein the UHMWPE material is supplied to the mould in the form of a powder.

5. Process according to claim 4, wherein the UHMWPE powder has an average particle size D50 as measured according to ISO-13320:2009 of <250 μm.

6. Process according to claim 1, wherein the compaction pressure is >1.0 MPa.

7. Process according to claim 1, wherein the mould is heated to a temperature of ≥145° C. and ≤180° C.

8. Process according to claim 1, wherein the compaction takes place at a temperature of ≥145° C.

9. Process according to claim 1, wherein the compaction time is ≥1.0 and ≤15.0 minutes.

10. Process according to claim 1, wherein the UHMWPE powder is supplied to the mould at room temperature.

11. Process according to claim 1, wherein the UHMWPE powder is supplied to the mould at a temperature of ≥70° C. and ≤190° C.

12. Shaped object produced according to the process of claim 1.

13. Shaped object according to claim 12, wherein the shaped object is a gear or an object with unlimited complexity in the plane parallel to the pressing punch of the mould.

14. (canceled)

15. (canceled)
